(19) United States
(12) Patent Application Publication
(10) Pub. No.: US 2013/0342229 A1
(43) Pub. Date: Dec. 26, 2013

(54) LIQUID CRYSTAL DISPLAY AND DEAD PIXEL TEST CIRCUIT AND METHOD FOR LIQUID CRYSTAL DISPLAY

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventor: YIN-ZHAN WANG, Shenzhen (CN)

(21) Appl. No.: 13/904,042

(22) Filed: May 29, 2013

(30) Foreign Application Priority Data
Jun. 26, 2012 (CN) 2012102121919

(51) Int. Cl. G09G 3/00

(52) U.S. Cl. CPC G09G 3/006
USPC 324/750.3

(57) ABSTRACT

A liquid crystal display includes a liquid crystal display panel and a test circuit. The liquid crystal panel includes a number of scanning lines and a number of data lines cooperatively forming a pixel cell. The test circuit includes a control unit, a gate driving circuit, a data driving circuit and a detecting circuit. The gate driving circuit and the data driving circuit respectively provide a scan pulse and a test pulse to the pixel cells. The test pulse includes a first voltage. After a predefined period for providing the scan pulse and the test pulse to the pixel cells, the detecting circuit detects a voltage of the data lines, and determines the pixel cell is damaged if the voltage of the data lines is equal to the first voltage. A test circuit and a test method for detecting damaged pixel cells are also provided.

### BACKGROUND

1. Technical Field

The present disclosure relates to liquid crystal displays and, particularly, to a liquid crystal display, a test circuit and a test method for testing dead pixels in the liquid crystal display.

2. Description of Related Art

Liquid crystal displays have thousands of pixels cells. When manufacturing a liquid crystal display, dead pixels detection is needed. A typical method for dead pixel detection is displaying a single color on the whole display, and an operator looks for dead pixels visually. It is ineffective and some of the dead pixels may be omitted.

Therefore, it is desirable to provide a new liquid crystal display and a method for testing dead pixels in the liquid crystal display.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding units throughout the several views.

FIG. 1 is a circuit diagram of a liquid crystal display, in accordance with an exemplary embodiment.

FIG. 2 is a graph of test pulses in the liquid crystal display shown as FIG. 1.

FIG. 3 is a flowchart of a test method for detecting dead pixels in the liquid crystal display, in accordance with an exemplary embodiment.

### DETAILED DESCRIPTION

Embodiments of the present disclosure are described with reference to the accompanying drawings.

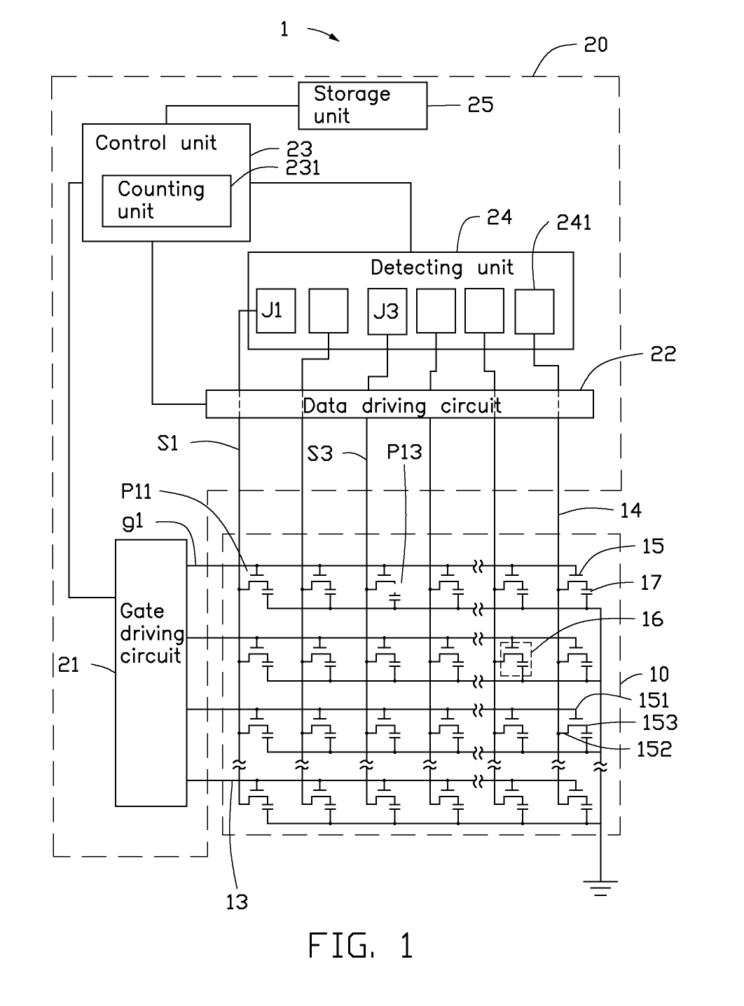

FIG. 1 shows an embodiment of the present disclosure of a liquid crystal display (LCD) 1. The liquid crystal display 1 includes a liquid crystal display panel 10 and a test circuit 20.

The liquid crystal display panel 10 includes a number of parallel scanning lines 13 and a number of parallel data lines 14. The parallel scanning lines 13 are perpendicularly intersected with the data lines 14 to form a number of pixel cells 16.

Each pixel cell 16 includes a thin-film transistor 15 and a liquid crystal capacitor 17. Each thin-film transistor 15 includes a gate 151, a source 152, and a drain 153. The gate 15 is connected to one scanning line 13, the source 152 is connected to one data line 14, and the drain 153 is connected to one liquid crystal capacitor 17. In this embodiment, the liquid crystal capacitor 17 includes a pixel electrode (not labeled) which is formed by the drain 153, a public electrode which is grounded, and a liquid crystal layer (not shown) arranged between the pixel electrode and the public electrode.

The test circuit 20 includes a gate driving circuit 21, a data driving circuit 22, a control unit 23, a detecting unit 24, and a storage unit 25.

The scanning lines 13 are connected to the gate driving circuit 21, and the data lines 14 are connected to the data driving circuit 22. The gate driving circuit 21 is configured to output scanning signals to the scanning lines 13 one by one to scan the liquid crystal display panel 10. The data driving circuit 22 is configured to output gray scale voltages to the data lines 14 when the liquid crystal display panel 10 is being scanned. The data driving circuit 22 is further configured to output test pulses to each pixel cell 16 when the liquid crystal display panel 10 is being scanned.

The detecting unit 24 is electrically connected to the data lines 14. The detecting unit 24 is configured to detect whether or not all pixel cells 16 are normal by detecting the voltages at the data lines 14. In this embodiment, the detecting unit 24 includes a number of detecting circuits 241. Each detecting circuit 241 is electrically connected to one data line 14 and is configured to detect the voltage at the data line 14. It can be understood that the number of the detecting circuits 241 is equal to the number of the data lines 14.

The control unit 23 is configured to trigger the gate driving circuit 21 to output the scanning signals and trigger the data driving circuit 22 to output the gray scale voltages or test pulses. The control unit 23 is further configured to control the detecting unit 24 to detect the state of each pixel cells 16, determine whether or not each pixel cell 16 is in a normal state according to the detected state.

The storage unit 25 is configured to store the scanning signal, the gray scale voltages and the test pulse. It can be understood that the scanning signal, the gray scale voltages and the test pulse may be stored in the storage unit 25 in form of digital signals.

The detail procedure of detecting the dead pixels will be described as below. A first pixel cell P11 and a second pixel cell P13 arranged in a same row and spaced by one pixel cell will be taken as an example to illustrate how to detect the dead pixels. The first pixel cell P11 is driven by the scanning line g1 and the data line S1, and the second pixel cell P13 is driven by the scanning line g1 and the data line S3.

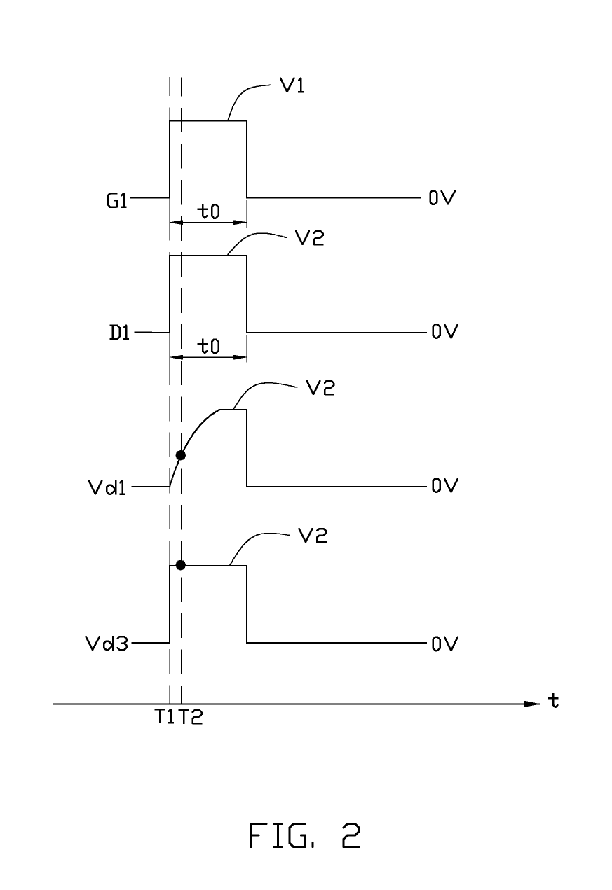

FIG. 2 shows that the curve G1 illustrates a scanning signal output from the gate driving circuit 21 to the scanning line g1. In this embodiment, the scanning signal is a scanning voltage pulse. A width of the scanning signal is t0. A high level of the scanning signal is a first voltage V1, and a low level of the scanning signal is zero. In this embodiment, the first voltage V1 is a threshold value to turn on the thin-film transistor 15. The curve D1 illustrates a test pulse outputted from the data driving circuit 22 to the data lines 14. In this embodiment, the width of the test pulse is t0. A high level of the test pulse is a second voltage V2. The curve Vd1 illustrates a voltage at the data line S1 which is generated when the data line S1 receives the test pulse D1 output by the data driving circuit 22. The curve Vd3 illustrates a voltage on the data line S3 which is generated when the data line S3 receives the test pulse D1 output by the data driving circuit 22.

The control unit 23 controls the gate driving circuit 21 to output the scanning signal G1 to the scanning line g1 at the time T1, to turn on the thin-film transistor 15 connected to the scanning line g1. Simultaneously, the control unit 23 further controls the data driving circuit 22 to output the test pulse D1 to the data lines 14, thus, the test pulse D1 charges the liquid crystal capacitors 17 via the source 152 of the thin-film transistors 15.

If the thin-film transistor 15 and the liquid crystal capacitors 17 of one pixel cell (e.g. the first pixel cell P11) are normal, the thin-film transistor 15 will be turned on when receiving the scanning signal G1, and the test pulse D1 will be transmitted from the source 152 to the drain 153 to charge the liquid crystal capacitor 17. The curve Vd1 of FIG. 2 shows that as the liquid capacitor 17 is charged gradually, the voltage at the data line S1 and the voltage at the source 152 and drain 153 will be pulled down to a low level at the time T1, and then gradually increase. When the liquid crystal capacitor 17 is fully charged, the voltage Vd1 at the data line S1 and the source 152 raise to a level equal to the second voltage V2 of the test pulse D1. That is, before the liquid crystal capacitor 17 is fully charged, when the voltage Vd1 on the data line S1 and the source 152 is less than the second voltage V2 of the test pulse D1, the thin-film transistor 15 is determined as normal, and the corresponding pixel cell P11 is defined as a good pixel cell.

If any of the thin-film transistor 15 and the liquid crystal capacitor 17 of one pixel cell (e.g. the second pixel cell P13) is damaged, the thin-film transistor 15 will not be turned on when receiving the scanning signal G1, and the test pulse D1 cannot be transmitted from the source 152 to the drain 153, thus the voltage Vd3 on the data line S3 and the source 152 of the thin-film transistor 15 and the second voltage V2 is synchronous, shown as the curve Vd3 of FIG. 2. That is, before the liquid crystal capacitor 17 is fully charged, when the voltage Vd3 on the data line S3 and the source 152 of the thin-film transistor 15 is equal to the second voltage V2 of the test pulse D1, the thin-film transistor 15 will be determined as abnormal, and the corresponding pixel cell P13 is defined as a dead pixel.

Therefore, whether or not a pixel cell 16 is in a normal state can be detected by detecting the voltage at the data line 14 forming the pixel cell 16 or the voltage on the source 152 of the corresponding thin-film transistor 15 before the liquid crystal capacitor 17 is fully charged.

In this embodiment, the control unit 23 controls the detecting circuits 241 to detect the voltage on the data lines 14 at a time T2 which is between the first time T1 and the time the liquid crystal capacitor 17 being fully charged. As shown in FIG. 1, the detecting circuit J1 and the detecting circuit J3 respectively detects the voltage Vd1 on the data line S1 and the voltage Vd3 on the data line S3. The detecting circuit 241 further transmits the detected voltage to the control unit 23. In this embodiment, the detecting circuits 241 are further configured to convert the detected voltages into digital signals before transmitting the detected voltage to the control unit 23.

After receiving the detected voltages from the detecting circuits 241, the control unit 23 obtains the second voltage V2 stored in the storage unit 25, and compares the detected voltages with the second voltage V2 to determine whether or not the pixel cells are normal. In this embodiment, when the voltage on the date line 14 is less than the second voltage V2, the control unit 23 determines that the pixel cell 16 the thin-film transistor 15 of which is connected to the data line 14 is normal, and when the voltage on the data line 14 is equal to the second voltage V2, the control unit 23 determines that the pixel cell 16 the thin-film transistor 15 of which is connected to the data line 14 is damaged, namely a dead pixel.

The control unit 23 is further configured to record the number of the dead pixels and the position of each dead pixel. In this embodiment, the position of each dead pixel cell 16 is determined by determining which detecting circuit 241 detects the voltage which is equal to the second voltage V2 at the data line and which scanning line is driven by the scanning signal. For example, the position of the dead pixel cell P13 is detected by the detecting circuit J3 and the scanning line g1.

In this embodiment, the pixel cells 16 from the first row to the last row are tested in turn, using the method described above.

In this embodiment, the control unit 23 further includes a counting unit 231. The counting unit 231 is configured to count the total number of dead pixels in the liquid crystal display panel 10.

It can be understood that the detecting circuit and method described above also can detect the abnormal pixel cells caused by a damage of data lines 14 and scanning lines g1.

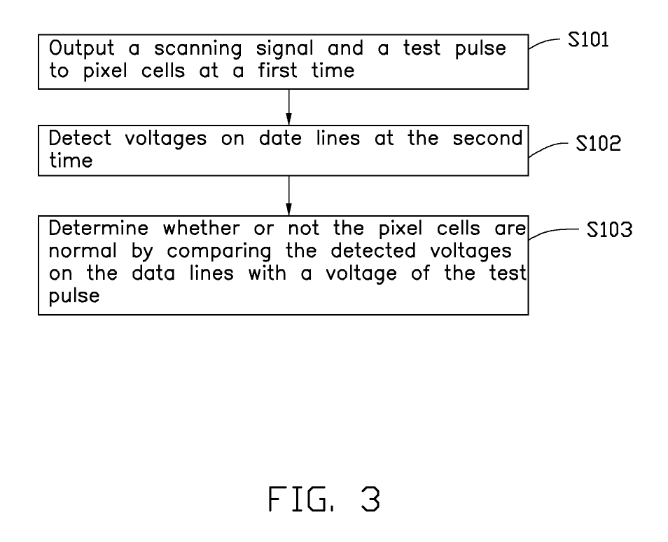

FIG. 3 shows a flowchart of a test method for detecting dead pixels in the liquid crystal display 1 in accordance with an exemplary embodiment.

In step S101, the control unit 23 controls the gate driving circuit 21 to output the scanning signals to a scanning line 16 at the time T1, and simultaneously controls the data driving circuit 22 to output the test pulses D1 to the pixel cells 16. In this embodiment, the control unit 23 controls the gate driving circuit 21 output the scanning signals to the scanning lines one by one.

In step S102, the detecting circuits 241 detect the voltage on the date lines 14 at the second time T2. In this embodiment, the second time T2 is between the first time T1 and the time of the liquid crystal capacitor 17 being fully charged.

In step S103, the control unit 23 determines whether or not a pixel cell 16 is normal by comparing the detected voltages on the data lines 14 which forms the pixel cell 16 with the second voltage V2 of the test pulse. In this embodiment, when the voltage on the date line 14 is less than the second voltage V2, the control unit 23 determines that the pixel cell 16 the thin-film transistor 15 of which is connected to the data line 14 is normal, and when the voltage on the data line 14 is equal to the second voltage V2, the control unit 23 determines that the pixel cell 16 the thin-film transistor 15 of which is connected to the data line 14 is damaged, namely a dead pixel.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A liquid crystal display comprising:
a liquid crystal display panel comprising:
a plurality of scanning lines and a plurality of data lines cooperatively forming a plurality of pixel cells; and
a test circuit comprising:
a control unit;
a gate driving circuit configured to output scanning signals to the scanning lines, wherein the scanning signal comprises a first voltage, and the scanning signals are sent to the scanning lines one by one;
a data driving circuit configured to output a test pulse to the data lines, wherein the test pulse comprises a second voltage; and
a detecting unit connected to the data lines to detect whether or not the pixel cells are normal;
wherein when one of the scanning lines is being scanned, and the scanning signals and the test pulses have been supplied to the pixel cells for a predetermined time interval, the control unit is configured to control the detecting unit to detect the voltage at each of the plurality of data lines and transmit the detected voltages to the control unit, the control unit is further configured to compare the detected voltages with the second voltage, and if determining that one of the detected voltage is equal to the second voltage, the control unit determines that the pixel cell formed by the scanning line and the data line is a dead pixel cell.

2. The liquid crystal display as described in claim 1, wherein each of the plurality of pixel cells comprises a thin-film transistor and a liquid crystal capacitor, each thin-film transistor comprises a gate, a source, and a drain, the gate is connected to one of the plurality of scanning lines, the source is connected to one of the plurality of data lines, and the drain is connected to the liquid crystal capacitor, the liquid crystal capacitor is not fully charged when the scanning signals and the test pulses have been supplied to the pixel cells for the predetermined time interval.

3. The liquid crystal display as described in claim 1, wherein the test circuit further comprises a storage unit to store the test pulse and the second voltage.

4. The liquid crystal display as described in claim 3, wherein the control unit is configured to obtain the voltage at the data lines from the detecting unit, and obtain the second voltage from the storage unit.

5. The liquid crystal display as described in claim 1, wherein the detecting unit comprises a plurality of detecting circuits, each of the plurality of detecting circuits is connected to one of the plurality of data lines and is configured to detect the voltage at the one of the plurality of data line, and the control unit is further configured to determine a position of the dead pixel cell by determining which scanning line is driven by the scanning signal and determining which detecting circuit detects the voltage equal to the second voltage.

6. The liquid crystal display as described in claim 1, wherein the control unit further comprises a counting unit to count the total number of dead pixel cells in the liquid crystal display panel.

7. A test circuit applied in a liquid crystal display, the liquid crystal display comprising a liquid crystal display panel, the liquid crystal display panel comprising a plurality of scanning lines and a plurality of data lines cooperatively forming a plurality of pixel cells, each of the plurality of pixel cells comprising a thin-film transistor and a liquid crystal capacitor, each thin-film transistor comprising a gate, a source, and a drain, the gate being connected to one of the plurality of scanning lines, the source being connected to one of the plurality of data lines, and the drain being connected to the liquid crystal capacitor, the test circuit comprising:
a control unit;
a gate driving circuit configured to output scanning signals to the scanning lines, wherein the scanning signal comprises a first voltage, and the scanning signals are sent to the scanning lines one by one;
a data driving circuit configured to output a test pulse to the data lines, wherein the test pulse comprises a second voltage; and
a detecting unit connected to the data lines to detect whether or not all the pixel cells are normal;
wherein when one of the scanning lines is being scanned, and the scanning signals and the test pulses have been supplied to the pixel cells for a predetermined time interval, the control unit is configured to control the detecting unit to detect the voltage at each of the plurality of data lines and transmit the detected voltages to the control unit, the control unit is further configured to compare the detected voltages with the second voltage, and if determining that one of the detected voltage is equal to the second voltage, the control unit determines that the pixel cell formed by the scanning line and the data line is a dead pixel cell.

8. The test circuit as described in claim 7, wherein the liquid crystal capacitor is not fully charged when the scanning signals and the test pulses have been supplied to the pixel cells for the predetermined time interval.

9. The test circuit as described in claim 7, further comprising a storage unit to store the test pulse and the second voltage.

10. The test circuit as described in claim 9, wherein the control unit is configured to obtain the voltage at the data lines from the detecting unit, and obtain the second voltage from the storage unit.

11. The test circuit as described in claim 7, wherein the detecting unit comprises a plurality of detecting circuits, each of the plurality of detecting circuits is connected to one of the plurality of data lines and is configured to detect the voltage at the one of the plurality of data line, and the control unit is further configured to determine a position of the dead pixel cell by determining which scanning line is driven by the scanning signal and determining which detecting circuit detects the voltage equal to the second voltage.

12. The test circuit as described in claim 7, wherein the control unit further comprises a counting unit to count the total number of dead pixel cells in the liquid crystal display panel.

13. A method for detecting dead pixel cells being applied to a liquid crystal display, the liquid crystal display comprising a liquid crystal display panel and a test circuit, the display panel comprising a plurality of scanning lines and a plurality of data lines cooperatively forming a plurality of pixel cells, the test circuit comprising a control unit, a gate driving circuit, and a data driving circuit, the gate driving circuit outputting scanning signals to the scanning lines, and the data driving circuit outputting test pulses to the data lines, the method comprising:
outputting the scanning signals to the scanning lines one by one via the gate driving circuit and simultaneously outputting the test pulses to the data lines via the data driving circuit, wherein the scanning signal comprises a first voltage, the test pulse comprises a second voltage;
detecting voltage on the data lines when one of the scanning line is being scanned and the scanning signals and the test pulses have been supplied to the pixel cells for a predetermined time interval; and
determining whether or not the pixel cells are normal by comparing the detected voltage on each data lines with the second voltage.

14. The method as described in claim 13, further comprising:
determining the pixel cell is normal if determining that the voltage on the date line is less than the second voltage, and
determining the pixel cell is a dead pixel if determining that the voltage on the data line is equal to the second voltage.

15. The method as described in claim 14, further comprising:
counting the total number of the dead pixels.

16. The method as described in claim 14, further comprising:
determining a position of the dead pixel cell by determining which scanning line is driven by the scanning signal and determining which detecting circuit detects the voltage equal to the second voltage.
